(19) United States
(12) Patent Application Publication
(10) Pub. No.: US 2024/0186040 A1
(43) Pub. Date: Jun. 6, 2024

(54) CONTINUOUS ULTA-RAPID ANNEALING OF NANOCRYSTALLINE SOFT MAGNETIC MATERIALS

(71) Applicant: KITE MAGNETICS, Notting Hill (AU)

(72) Inventor: Richard PARSONS, Notting Hill (AU)

(21) Appl. No.: 18/114,417

(22) Filed: Feb. 27, 2023

Related U.S. Application Data
(60) Provisional application No. 63/430,133, filed on Dec. 5, 2022.

(51) Int. Cl. H01F 1/153; C21D 1/26; C21D 9/52; C22C 45/00; H02K 1/02

(52) U.S. Cl. CPC H01F 1/1535; C21D 1/26; C21D 9/52; C22C 45/008; H01F 1/15333; H02K 1/02; C21D 2201/03; C22C 2200/04

(57) ABSTRACT

A Continuous Ultra-Rapid Annealing (CURA) method for producing a nanocrystalline alloy is provided. The method includes placing amorphous ribbons on a first reel, preheating a Cu wheel to a temperature of about 750° K to about 800° K, and unwinding the amorphous ribbons from the first reel to a second reel. The methods include directly contacting the amorphous ribbons between the first reel and the second reel with the Cu wheel for a length of time and under tension to produce the nanocrystalline alloy. The methods include winding the nanocrystalline alloy on the second reel.

### CROSS-REFERENCE TO RELATED APPLICATIONS

This application claims priority to 63/430,133 filed Dec. 5, 2022, entitled “Nanocrystalline soft magnetic materials produced by Continuous Ultra-Rapid Annealing (CURA) and an Electric Motor Having a Nanocrystalline Stator”, the disclosure of which is incorporated herein by reference in its entirety.

### TECHNICAL FIELD

The present disclosure generally relates to novel methods of producing Fe-rich nanocrystalline soft magnetic materials with desirable soft magnetic properties.

### BACKGROUND

Unless otherwise indicated herein, the materials described in this section are not prior art to the claims in this application and are not admitted being prior art by inclusion in this section.

Nanocrystalline soft magnetic materials may be used in applications such as current sensing, power filtering and high-frequency transformers. Electric motors may use nanocrystalline stator cores which may have a higher efficiency than equivalent motors produced using amorphous or Fe—Si steel stator cores. Nanocrystalline cored electric motors and other devices may require nanocrystalline material with a saturation magnetic polarization (Js) equal to, or greater than, that of Fe—Si steels to have both high efficiency and high specific power density.

Ultra-Rapid Annealing (URA) may produce nanocrystalline soft magnetic materials with a Js comparable to that of Fe—Si steels (1.85 to 2.02 T) while also maintaining a low coercivity (2.5 to 9.3 A/m)8-10. However, high heating rates (>10⁴ K/s) and short annealing time (<3 s) required by URA compared to conventional annealing techniques, along with the effects of latent heating during primary crystallization, may limit scalability of URA as well as batch processing and the brittleness of annealed ribbons produced by URA.

### SUMMARY

Existing challenges associated with the foregoing, as well as other challenges, are overcome by the presently disclosed Continuous Ultra-Rapid Annealing (CURA) of nanocrystalline soft magnetic materials. CURA is a reel-to-reel annealing technique where an amorphous ribbon is brought into direct contact with a preheated Cu wheel for a short length of time (<3 s) whilst under tension. The ribbon experiences annealing conditions comparable to the existing URA technique and produces nanocrystalline soft magnetic materials with similar magnetic properties.

One embodiment of the present disclosure is a Continuous Ultra-Rapid Annealing (CURA) method for producing a nanocrystalline alloy. The method includes placing amorphous ribbons on a first reel, preheating a Cu wheel to a temperature of about 700° K to about 800° K, and unwinding the amorphous ribbons from the first reel to a second reel. The methods include directly contacting the amorphous ribbons between the first reel and the second reel with the Cu wheel for a length of time and under tension to produce the nanocrystalline alloy. The methods include winding the nanocrystalline alloy on the second reel.

In aspects, the alloy includes a Fe-rich material.

In aspects, the alloy includes (Fe_{0.8}Co_{0.2})₈₆B₁₄.

In aspects, the length of time is less than about ten seconds.

In aspects, the length of time is less than about three seconds.

In aspects, the tension is about 10 MPa.

In aspects, the amorphous ribbons are directly contacted with the Cu wheel under a nitrogen flow atmosphere.

In aspects, the method further incudes air cooling the nanocrystalline alloy.

Another embodiment of the present disclosure includes a nanocrystalline (Fe_{0.8}Co_{0.2})₈₆B₁₄ alloy produced by a CURA process. The CURA process includes directly contacting amorphous ribbons between a first reel and a second reel with a preheated Cu wheel for a length of time under tension to produce the nanocrystalline (Fe_{0.8}Co_{0.2})₈₆B₁₄ alloy.

In aspects, the nanocrystalline (Fe_{0.8}Co_{0.2})₈₆B₁₄ alloy has a saturation magnetic polarization greater than 2 T and a coercivity less than 10 A/m.

In aspects, the nanocrystalline (Fe_{0.8}Co_{0.2})₈₆B₁₄ alloy is used to prepare a stator.

In aspects, the stator is part of an electric motor.

Another embodiment of the present disclosure includes a Continuous Ultra-Rapid Annealing (CURA) method for producing a nanocrystalline alloy. The method includes directly contacting amorphous ribbons between a first reel and a second reel with a preheated Cu wheel for a length of time under tension to produce the nanocrystalline alloy.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a system for Continuous Ultra-Rapid Annealing (CURA) according to the present disclosure;

FIG. 2 illustrates XRD patterns of as-cast, Ultra-Rapid Annealing (URA) and CURA ribbons of (Fe_{0.8}Co_{0.2})₈₆B₁₄ according to the present disclosure;

FIG. 3 illustrates Thermo-magneto-gravimetric analysis (TMGA) signals acquired from the same as-cast, URA and CURA samples of (Fe_{0.8}Co_{0.2})₈₆B₁₄ according to the present disclosure;

FIG. 4 illustrates pseudo-DC (˜0.1 Hz) hysteresis curves acquired using a 10 cm Epstein frame for samples processed by URA and CURA according to the present disclosure;

FIG. 5 illustrates Core Loss, P_{cm}, estimated at 50, 400 and 1000 Hz for URA and CURA ribbons of (Fe_{0.8}Co_{0.2})₈₆B₁₄ along with commercially produced 0.35 mm thickness non-oriented 3 wt % Fe—Si steel according to the present disclosure;

FIG. 6 displays coercivity, electrical resistance and saturation magnetic polarization as measured at different points along the length of a CURA ribbon according to the present disclosure;

FIG. 7 illustrates a stator with a (Fe_{0.8}Co_{0.2})₈₆B₁₄ nanocrystalline stator core produced using CURA and an electric motor with the stator with the (Fe_{0.8}Co_{0.2})₈₆B₁₄ nanocrystalline stator core according to the present disclosure;

FIG. 8 displays the performance of an unmodified motor with a Fe—Si steel stator core and the same motor modified to use a (Fe_{0.8}Co_{0.2})₈₆B₁₄ nanocrystalline stator core produced using CURA according to the present disclosure;

FIG. 9 displays the performance of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure;

FIG. 10 displays the power draw of the inverter and electric motor versus thrust of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure;

FIG. 11 displays the power draw of the motor and inverter versus thrust of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure; and

FIG. 12 displays the thrust per unit input power at the inverter for an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the disclosure and the claims.

Novel methods for producing nanocrystalline soft magnetic materials are discussed herein. In the following description, for purposes of explanation, numerous specific details are set forth in order to provide a thorough understanding of the present disclosure. It will be evident, however, to one skilled in the art that the present disclosure may be practiced without these specific details.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure may comprise nanocrystalline soft magnetic materials and methods to make nanocrystalline soft magnetic materials. The method may include placing amorphous ribbons on a first reel. The method may include preheating a Cu wheel. The Cu wheel may be preheated to a temperature of about 700° K to about 800° K. The method may include unwinding the amorphous ribbons from the first reel to a second reel. The methods may include directly contacting the amorphous ribbons between the first reel and the second reel with the Cu wheel for a length of time and under tension to produce the nanocrystalline alloy. The methods may include winding the nanocrystalline alloy on the second reel.

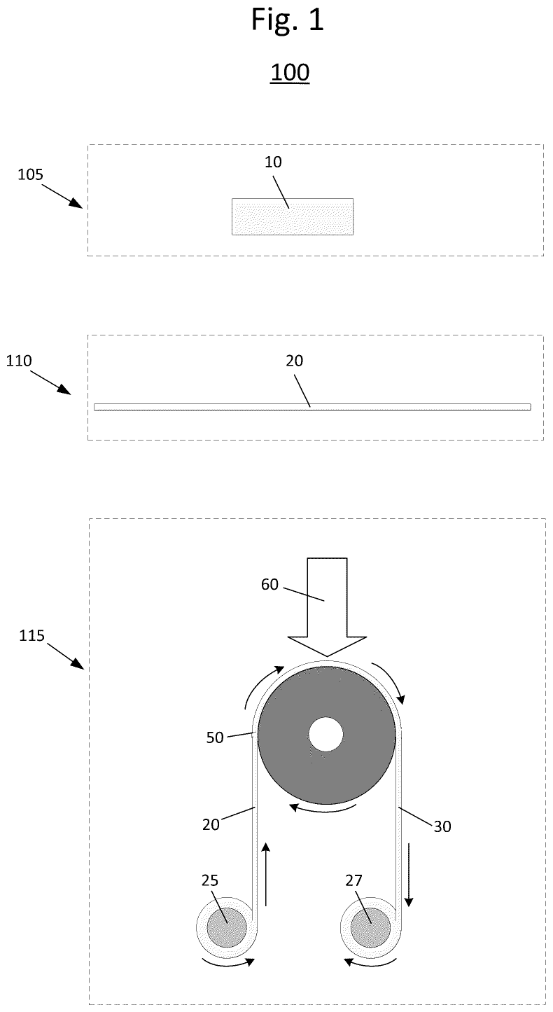

FIG. 1 illustrates an example system or method that can be utilized to produce nanocrystalline soft magnetic materials according to the present disclosure, arranged in accordance with at least some embodiments presented herein.

System 100 may include ingot 10. Ingot 10 may be a Fe-rich material. Ingot 10 may include a nominal composition of (Fe_{0.8}Co_{0.2})₈₆B₁₄. At 105, Ingot 10 may be prepared by arc melting in an argon (Ar) atmosphere.

At 110, ingot 10 may undergo planar flow casting in an inert atmosphere of reduced pressure to produce amorphous ribbons 20. Amorphous ribbons 20 may have an average thickness of 22 μm and a width of 12 mm.

At 115, amorphous ribbons 20 may undergo Continuous Ultra-Rapid Annealing (CURA). CURA may be a reel-to-reel processing technique. Amorphous ribbons 20 may be placed on a first reel 25. A copper (Cu) wheel 50 may be preheated to a temperature of about 750° K to about 800° K. Amorphous ribbons 20 may be unwound from first reel 25 and wound on to a second reel 27. While amorphous ribbons 20 are unwound/wound, amorphous ribbons 20 between first reel 25 and second reel 27 may be brought into direct contact with preheated Cu wheel 50 for a short length of time of less than about ten seconds, more preferably less than about three seconds to anneal amorphous ribbons 20. Amorphous ribbons 20 may be under a tension of about 10 MPa while amorphous ribbons 20 are unwound/wound. After contact with preheated Cu wheel 50 under tension, amorphous ribbons 20 may be annealed to form annealed ribbons 30 and annealed ribbons 30 may be wound onto second reel 27. CURA may be conducted in a nitrogen flow atmosphere and nitrogen 60 may be flowed over amorphous ribbons 20 as they contact preheated Cu wheel 50. Annealed ribbons 30 may be air-cooled post-annealing. Amorphous ribbons 20 may experience annealing conditions while in contact with preheated Cu wheel 50 comparable to existing Ultra-Rapid Annealing (URA).

CURA of amorphous ribbons 20 may change physical and chemical properties of amorphous ribbons 20 to produce annealed ribbons 30. Annealed ribbons 30 may be nanocrystalline soft magnetic materials with desirable magnetic properties. Annealed ribbons 30 may be a nanocrystalline (Fe_{0.8}Co_{0.2})₈₆B₁₄ alloy and have a saturation magnetic polarization greater than 2 T and a coercivity less than 10 A/m. CURA may be a reel-to-reel process and may be easily scaled for high volume, industrial-scale production as well as removing the need for direct handling of individual delicate ribbons.

### Experimental Example

Ingots with a nominal composition of (Fe_{0.8}Co_{0.2})₈₆B₁₄ were prepared by arc melting in an Argon (Ar) atmosphere. Amorphous ribbons were produced with an average thickness of 22 μm and a width of 12 mm by planar flow casting of the ingots in an inert atmosphere of reduced pressure. X-Ray Diffraction (XRD) patterns were collected with a Bruker D8 diffractometer using a Co K_{α} source from the non-wheel contacting side of each ribbon and Scherrer's formula was utilized for grain size (D) estimation. A saturation magnetic polarization (Jₛ=μ₀Mₛ) of the ribbons was estimated using a Riken Denshi BHV-35H vibrating sample magnetometer (VSM) calibrated with a Ni standard and with an applied magnetic field of up to 0.8 MA/m. A density of the ribbons was assumed to be 7640 kg/m³ in the as-cast state and 7720 kg/m³ in the nanocrystalline state. Thermo-magneto-gravimetric analysis (TMGA) was conducted using a Perkin Elmer TGA7 for estimation of the crystallization onset temperatures. A resistivity of the ribbons was estimated using a four-wire technique. Coercivity (Hc) estimations of the ribbons were made using a Riken Denshi BHS-40 DC hysteresis loop tracer while specific core loss (Pcm) was estimated using an Iwatsu SY-8219 BH Analyzer. Both Hc and Pcm were estimated using a custom 10 cm Epstein frame. CURA was conducted by bringing an amorphous ribbon into direct contact with a Cu wheel preheated to 748 K for 0.5 s with a tension of 10 MPa in a reel-to-reel process. CURA was conducted in a nitrogen flow atmosphere and air-cooled post-annealing. Unless stated otherwise, all properties for the CURA prepared samples presented in this study were obtained from a representative section of ribbon taken from the middle of each batch.

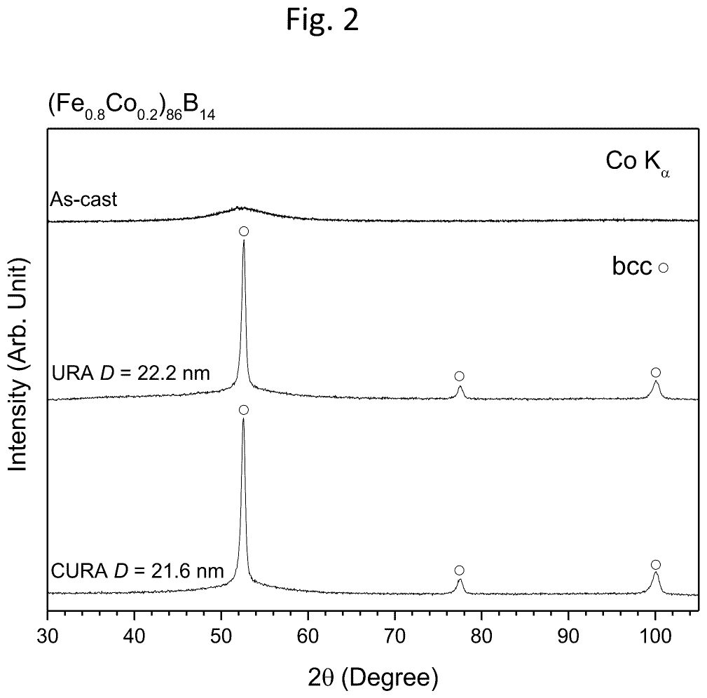

FIG. 2 displays XRD patterns acquired from samples of (Fe_{0.8}Co_{0.2})₈₆B₁₄ in the as-cast state and after nanocrystallization by URA and CURA according to the present disclosure, arranged in accordance with at least some embodiments presented herein.

As shown in FIG. 2, no crystallization peaks are observed for the as-cast samples suggesting complete amorphization. For the URA and CURA prepared samples only bcc crystallization reflection peaks are observed with grain sizes (D) of 22.2 nm and 21.6 nm, respectively. This difference is considered to be within the experimental uncertainty of ±1 nm. This finding suggests that the annealing conditions of the two techniques are comparable as grain size D is well established to be sensitive to the heating rate and annealing time for Fe-based nanocrystalline alloys.

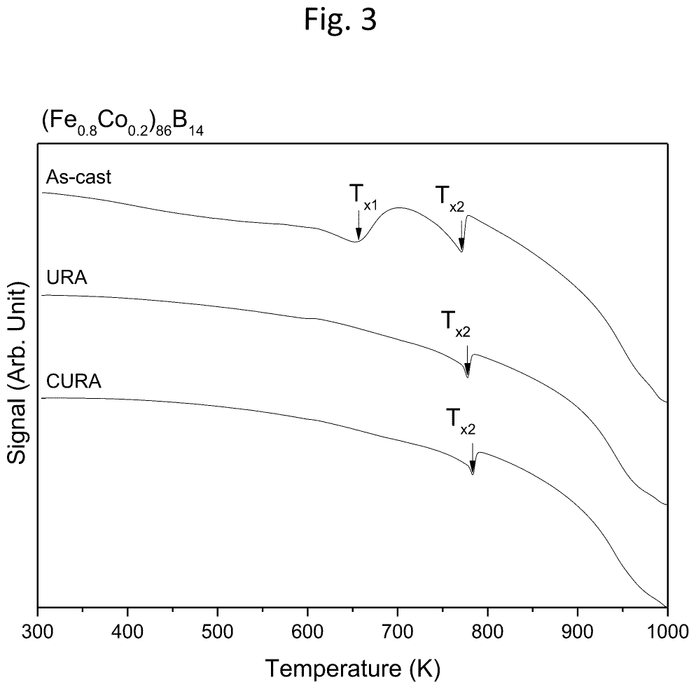

FIG. 3 displays TMGA signals acquired from the same as-cast, URA and CURA samples of (Fe_{0.8}Co_{0.2})₈₆B₁₄ according to the present disclosure, arranged in accordance with at least some embodiments presented herein.

The as-Cast TMGA signal suggests that the onset of primary (Tₓ₁) and secondary (Tₓ₂) crystallization occurs at 656 K and 771 K, respectively. The Curie temperature (TC) of the as-cast amorphous phase is not observed as the substitution of Fe for Co is well known to increase TC for Fe-rich amorphous materials beyond Tₓ₁. The ribbons processed by URA and CURA do not have an observable Tₓ₁ and share a similar Tₓ₂ value which further supports the suggestion that the two annealing techniques result in an equivalent microstructure.

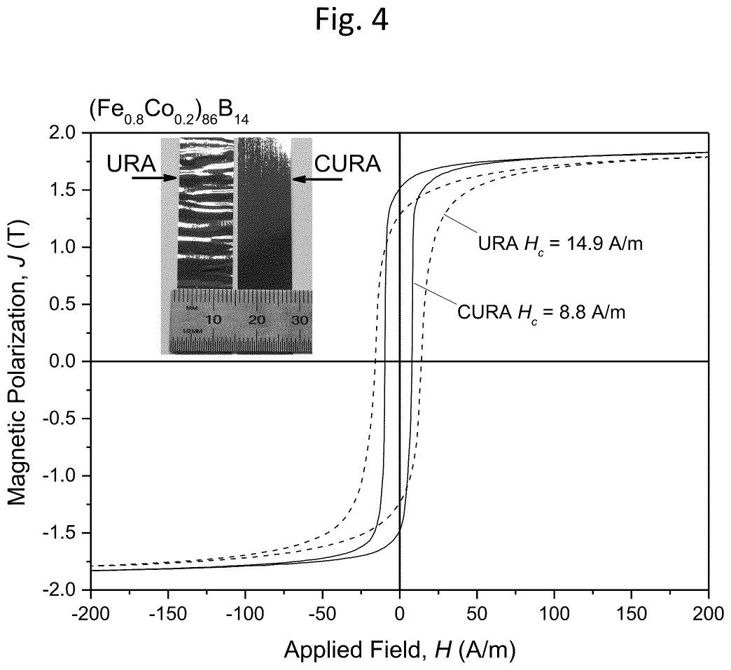

FIG. 4 displays pseudo-DC (˜0.1 Hz) hysteresis curves acquired using a 10 cm Epstein frame for samples processed by URA and CURA according to the present disclosure, arranged in accordance with at least some embodiments presented herein.

The CURA prepared ribbons are seen to have a lower coercivity (Hc) at 8.8 A/m than the URA prepared ribbons at 14.9 A/m. As the composition and grain size is equivalent between the two samples, this finding suggests that the URA and CURA processes may produce differences in the coherence of induced anisotropies (Ku) present within each sample. It is well-known that Fe—Co based nanocrystalline alloys exhibit a large annealing induced anisotropy (Ku) due to the pair ordering effect. Thus, the wall coercivity of nanocrystalline (Fe_{0.8}Co_{0.2})₈₆B₁₄ is governed not only by the random magnetocrystalline anisotropy (<K₁>) but also by the special fluctuations of Kᵤ. The lower H_{c} value of the CURA prepared sample is accompanied by a higher squareness. This suggests that the coherence of Kᵤ with an easy direction along the ribbon axis is enhanced. It has been shown that the squareness of nanocrystalline ribbons is enhanced by stress annealing when the local magnetostriction (λₛ) of the nanocrystallites is positive. Since λₛ of Fe₈₀Co₂₀ is positive (32 ppm), the observed higher remanence ratio for the CURA processed ribbons can be attributed to this creep-induced effect brought about by the moderate 10 MPa tension applied during annealing. Our results demonstrate that moderate stress applied during ultra-rapid annealing is effective in enhancing the coherence of annealing induced Kᵤ and thereby reducing the coercivity.

Also shown in FIG. 4 as an inset are URA and CURA prepared samples. Corrugations are shown that run perpendicular to the ribbon long axis for the URA prepared samples and are absent for the CURA samples. These corrugations on the URA sample are thought to be the result of the thermal expansion of the ribbons, and the Cu packets used to contain them, while they are constrained between two pre-heated copper blocks during crystallisation. In comparison, constant tension of 10 MPa was applied uniformly to the CURA prepared ribbon and the surface was unconstrained and so no corrugations were produced.

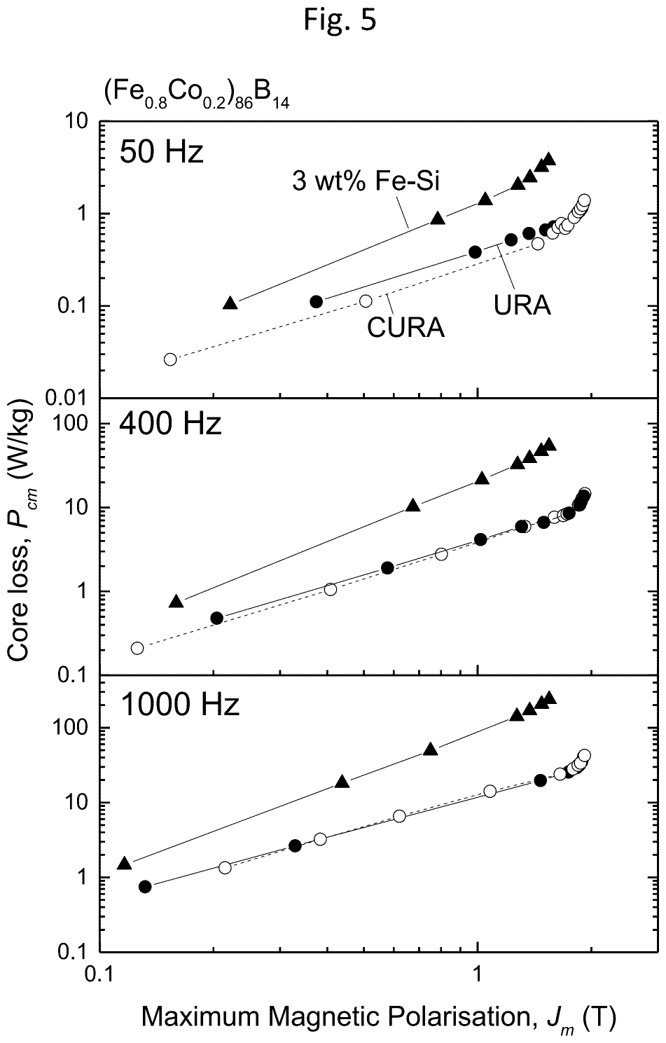

FIG. 5 displays Core Loss, P_{cm} estimated at 50, 400 and 1000 Hz for URA and CURA ribbons of (Fe_{0.8}Co_{0.2})₈₆B₁₄ along with commercially produced 0.35 mm thickness non-oriented 3 wt % Fe—Si steel according to the present disclosure, arranged in accordance with at least some embodiments presented herein.

For all frequencies and magnetization values that could be observed with a maximum applied field of 2000 A/m the core loss of the CURA and URA samples was a multiple of 4 to 10 smaller than that of the 0.35 mm thick non-oriented 3 wt % Fe—Si steel, with the highest frequencies and applied fields showing the greatest differences. The magnetic properties of the URA and CURA prepared samples of (Fe_{0.8}Co_{0.2})₈₆B₁₄ are summarized in Table I.

TABLE I
The magnetic properties of URA and CURA
prepared samples of (Fe_{0.8}Co_{0.2})₈₆B₁₄.

| | URA | | CURA | |
|---|---|---|---|---|
| DC Coercivity (H_{c}) | 14.9 ± 0.1 | A/m | 8.8 ± 0.1 | A/m |
| Remanence (Jᵣ) | 1.26 ± 0.01 | T | 1.50 ± 0.01 | T |
| Saturation Magnetic | 2.00 ± 0.01 | T | 2.00 ± 0.01 | T |
| Polarization (Jₛ) | | | | |
| Squareness Ratio (Jᵣ/Jₛ) | 0.63 | | 0.75 | |
| Core loss 50 Hz, 1.5 T | 0.62 | W/kg | 0.50 | W/kg |
| (P_{cm}) | | | | |
| Core loss 400 Hz, 1.5 T | 6.6 | W/kg | 6.9 | W/kg |
| (P_{cm}) | | | | |
| Core loss 1000 Hz, 1.5 T | 20.1 | W/kg | 20.6 | W/kg |

(P_{cm})

Jₛ for the URA and CURA prepared samples, as estimated by VSM, was seen to be equivalent at 2.0 T and is comparable to similar compositions. The core loss is seen to be ˜25% lower for the CURA sample at 50 Hz and 1.5 T but marginally higher at 1 kHz and 1.5 T. This difference suggests that the anomalous loss contribution is greater for the CURA prepared sample, presumably because of the 180° domain walls stabilized by the induced uniaxial anisotropy. This finding suggests that additional reductions in the core loss of CURA prepared samples may be achievable through tailoring of the hysteresis loop by adjusting the applied tension.

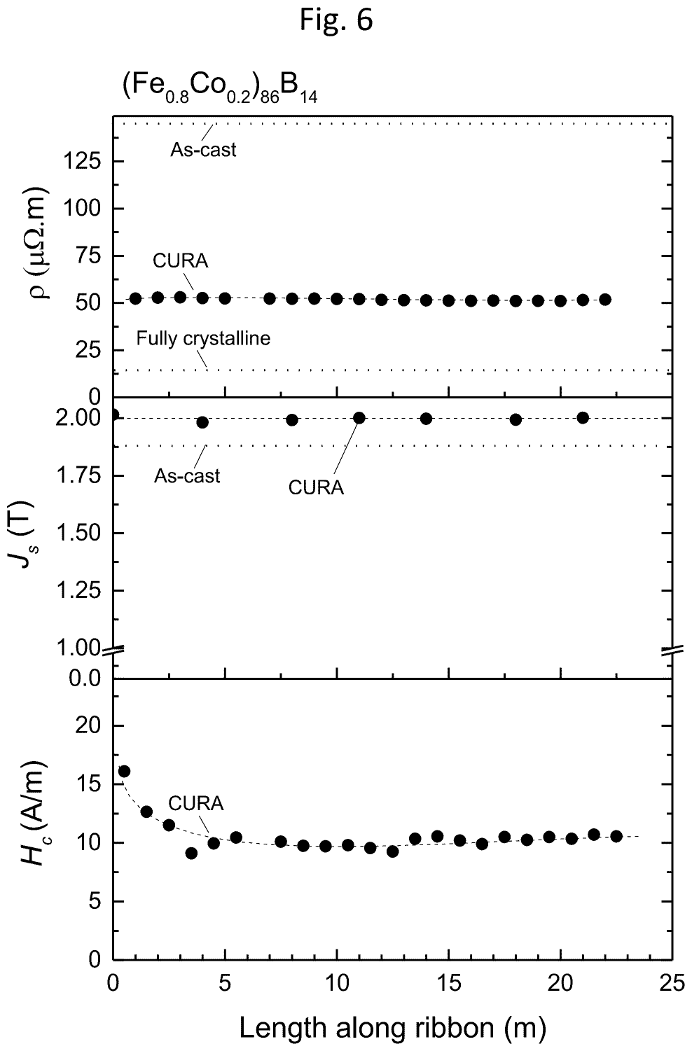

FIG. 6 displays coercivity, electrical resistance and saturation magnetic polarization as measured at different points along the length of a CURA ribbon according to the present disclosure, arranged in accordance with at least some embodiments presented herein.

A 23 m long, 12 mm wide (Fe_{0.8}Co_{0.2})₈₆B₁₄ ribbon underwent CURA and its properties were characterised at fixed intervals as shown in FIG. 6. Electrical resistivity was investigated as it is a well-established technique for tracing the phase transformations in solids. Little variation in p is seen along the length of the ribbon when compared to the values obtained for an as-cast sample or to a sample that was annealed in a tube furnace for 3.6 ks at 976 K to completely remove the amorphous phase. As the electrical resistivity of nanocrystalline alloys is sensitive to the volume fractions and compositions of the residual amorphous phase and the crystalline phase this finding suggests that the microstructure is consistent along the length of the ribbon. This is also supported by the values of Jₛ shown in FIG. 6 which suggests little variation along the length of the ribbon outside of the experimental uncertainty. The H_{c} of the ribbon is seen to vary from a maximum of 16.1 A/m to a minimum of 9.1 A/m for this specific sample batch. This variation is the greatest at the beginning of the ribbon, suggesting that there is some settling time required for the casting conditions or annealing conditions to reach a steady-state value. Therefore, if the first few meters of ribbon were to be discarded then FIG. 6 suggests that the CURA process can be used for the continuous production of Fe-rich nanocrystalline soft magnetic materials with a Jₛ greater than 2 T and a H_{c} of approximately 10 A/m.

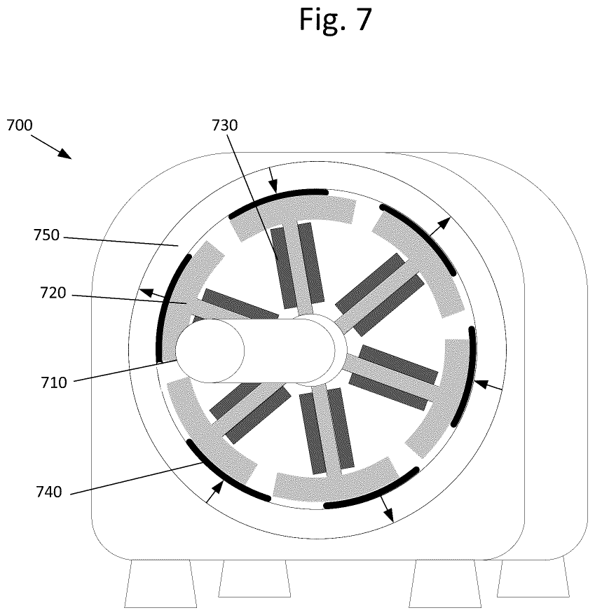

FIG. 7 illustrates a stator with a (Fe_{0.8}Co_{0.2})₈₆B₁₄ nanocrystalline stator core produced using CURA and an electric motor with the stator with the (Fe_{0.8}Co_{0.2})₈₆B₁₄ nanocrystalline stator core according to the present disclosure, arranged in accordance with at least some embodiments presented herein.

An electric motor 700 may be produced to rotate a shaft 710 to act on a load. Electric motor 700 may include stators 720, conductors 730, magnets 740, and a rotor 750. Conductors 730 may include nanocrystalline alloy produced by CURA. Conductors 730 may include (Fe_{0.8}Co_{0.2})₈₆B₁₄ nanocrystalline alloy produced by CURA.

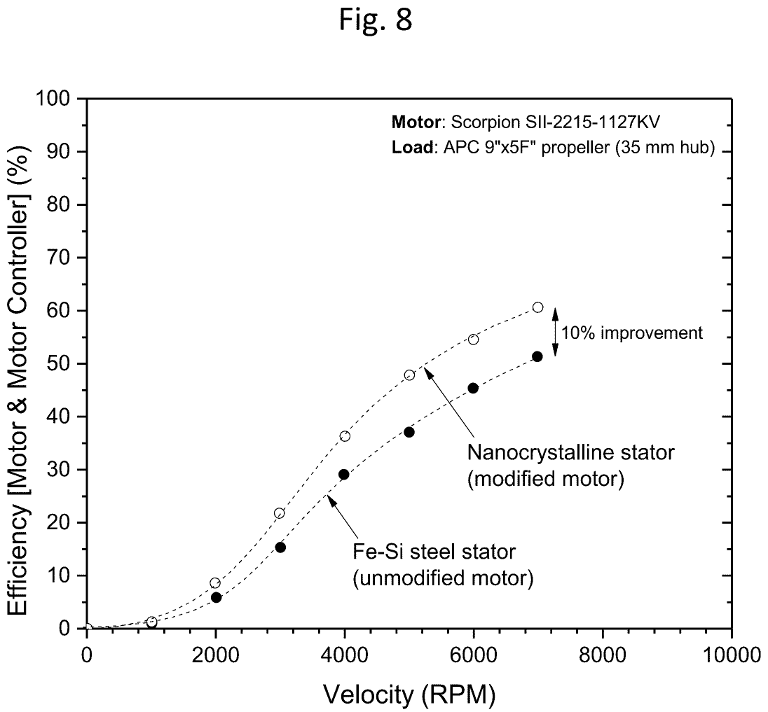

FIG. 8 displays the performance of an unmodified motor with a Fe—Si steel stator core and the same motor modified to use a (Fe_{0.8}Co_{0.2})₈₆B₁₄ nanocrystalline stator core produced using CURA according to the present disclosure, arranged in accordance with at least some embodiments presented herein.

FIG. 8 displays the performance of an unmodified consumer off the shelf electric motor (Model SII-2215-1127 KV by Scorpion Power Systems with 14 poles, 12 slots and rated at 296 W) which uses a Fe—Si steel stator core with 0.2 mm thick laminations. For comparison, the performance of the same motor modified to use a (Fe_{0.8}Co_{0.2})₈₆B₁₄ nanocrystalline stator core produced by CURA is also shown.

A geometry and mass of the motor modified to use a (Fe_{0.8}Co_{0.2})₈₆B₁₄ nanocrystalline stator core produced by CURA was approximately the same as the stock stator. The armature was wound with wire of the same diameter and with the same number of turns as the stock motor and the same rotor was used for testing of both motors. The motors were loaded with a propeller (9″×5F″ by APC), the thrust and torque were measured by load cells and the speed was reported by a shaft coupled encoder on a custom test stand. The power draw was estimated by an inline current shunt and voltage meter between the power supply and an Odrive Robotics V3.6 56V motor controller which was also used for data logging.

From FIG. 8 it can be seen that the combined efficiency of the motor and motor controller is increased by up to 10% at 7000 RPM (˜800 Hz fundamental frequency) by the replacement of the stock Fe—Si steel stator core with the (Fe_{0.8}Co_{0.2})₈₆B₁₄ nanocrystalline stator core. As all other aspects of the motor and its controller were left unchanged this improvement is attributed to the reduced core loss of nanocrystalline (Fe_{0.8}Co_{0.2})₈₆B₁₄ compared to Fe—Si steel. This simplistic proof of concept electric motor demonstrates that the CURA process can be used for the production of Fe-rich nanocrystalline soft magnetic materials with sufficient quantity and quality that they can be machined into complex geometries and used with existing commercial applications.

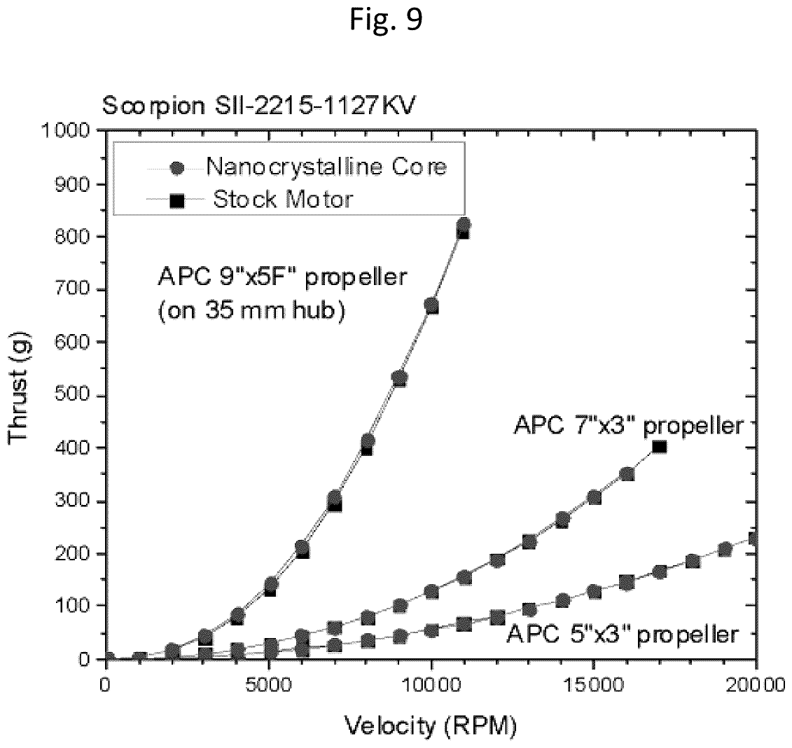

FIG. 9 displays the performance of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure, arranged in accordance with at least some embodiments presented herein.

FIG. 9 displays thrust and velocity curves for the shelf electric motor (Model SII-2215-1127 KV by Scorpion Power Systems with 14 poles, 12 slots and rated at 296 W) with a Fe—Si steel stator core with 0.2 mm thick laminations and the performance of the same motor modified to use a (Fe_{0.8}Co_{0.2})₈₆B₁₄ nanocrystalline stator core produced by CURA for three different propeller sizes: (1) 9″ Diameter with 5″ pitch, (2) 7″ Diameter with 3″ pitch, and (3) 5″ Diameter with 3″ pitch. As shown in FIG. 9, the speed and thrust capability of the motor modified to use a (Fe_{0.8}Co_{0.2})₈₆B₁₄ nanocrystalline stator core produced by CURA matches the stock electric motor.

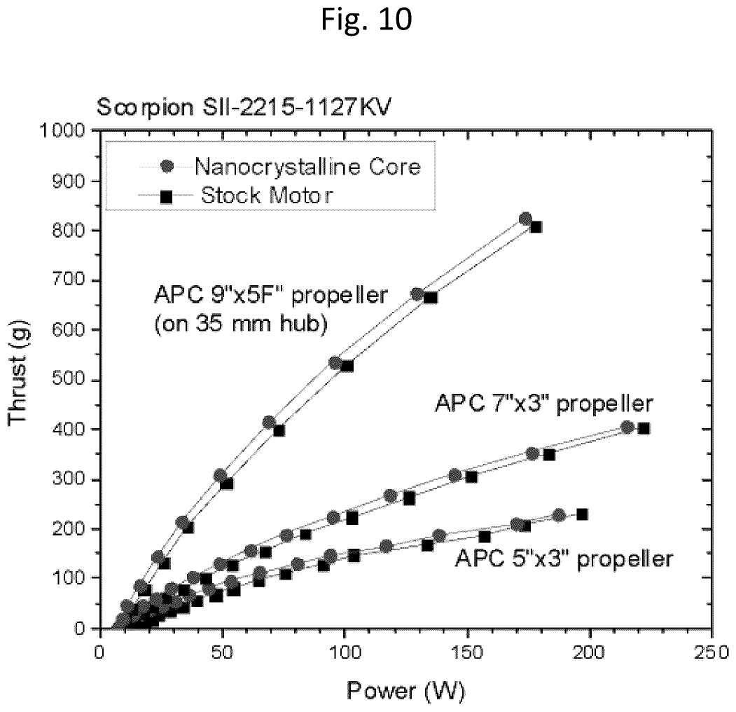

FIG. 10 displays the power draw of the inverter and electric motor versus thrust of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure, arranged in accordance with at least some embodiments presented herein.

As shown in FIG. 10, for each propeller size, (1) 9″ Diameter with 5″ pitch, (2) 7″ Diameter with 3″ pitch, and (3) 5″ Diameter with 3″ pitch, the nanocrystalline core motor shows a lower power draw for an equivalent thrust. The power draw includes power losses within the motor controller and cables supplying motor and non-motor power losses should be equal for both motors as the same test bench was used.

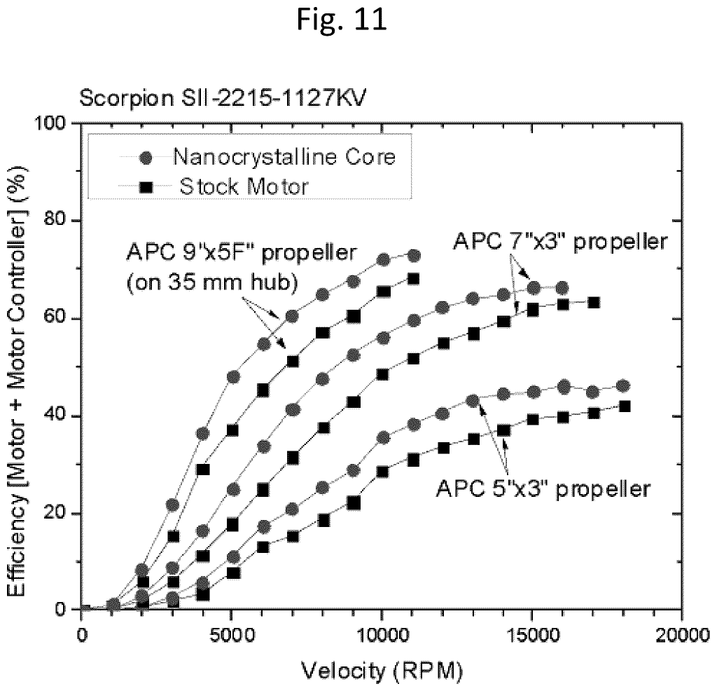

FIG. 11 displays the power draw of the motor and inverter versus thrust of an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure, arranged in accordance with at least some embodiments presented herein.

As shown in FIG. 11, the motor modified to use a (Fe_{0.8}Co_{0.2})₈₆B₁₄ nanocrystalline stator core produced using CURA resulted in an approximately 10% increase in motor efficiency over the stock motor, regardless of the size of the propeller used. The higher the motor loading, the lower the fraction of total power loss in the ferromagnetic core and so a smaller increase in efficiency was observed.

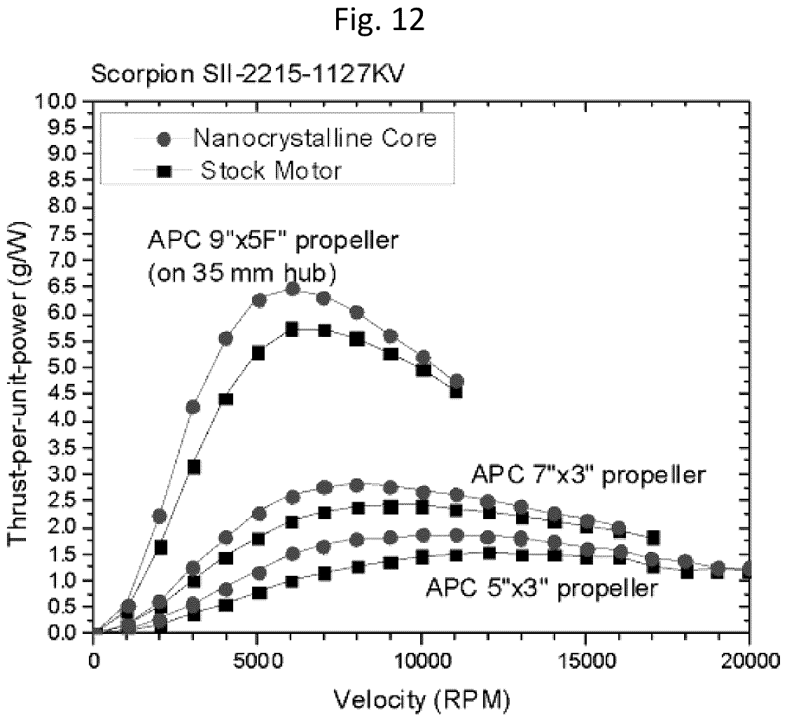

FIG. 12 displays the thrust per unit input power at the inverter for an unmodified motor with a Fe—Si steel stator core and the same motor modified to use a (Fe_{0.8}Co_{0.2})₈₆B₁₄ nanocrystalline stator core produced using CURA for three propeller sizes according to the present disclosure, arranged in accordance with at least some embodiments presented herein.

FIG. 12 displays that the motor modified to use a (Fe_{0.8}Co_{0.2})₈₆B₁₄ nanocrystalline stator core produced using CURA resulted in increased thrust per unit input power at the inverter over the stock motor, with the greatest improvement over 4-7 kRPM range. The largest increase was for small, fast spinning propeller with 45%, 22% and 19% relative increases in thrust per unit power for the 5×3, 7×3 and 9×5F propellers respectively.

A system in accordance with the present disclosure may produce nanocrystalline (Fe_{0.8}Co_{0.2})₈₆B₁₄ with a Continuous Ultra-Rapid Annealing (CURA) process while maintaining a saturation magnetic polarization greater than 2 T and a coercivity less than 10 A/m. A system in accordance with the present disclosure may produce CURA materials with microstructural and magnetic properties comparable to existing Ultra-Rapid Annealing (URA) technique except for induced anisotropy. A system in accordance with the present disclosure may produce CURA prepared nanocrystalline soft magnetic materials with sufficient quantity and quality which can be machined into complex geometries and used with existing commercial applications. A system in accordance with the present disclosure may produce CURA prepared nanocrystalline soft magnetic materials which can be used in electric motors, electric generators, electronic components, and filtering or shielding components.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. A Continuous Ultra-Rapid Annealing (CURA) method for producing a nanocrystalline alloy, the method comprising:
placing amorphous ribbons on a first reel;
preheating a Cu wheel to a temperature of about 750° K to about 800° K;
unwinding the amorphous ribbons from the first reel to a second reel;
directly contacting the amorphous ribbons between the first reel and the second reel with the Cu wheel for a length of time and under tension to produce the nanocrystalline alloy; and
winding the nanocrystalline alloy on the second reel.

2. The CURA method of claim 1, wherein the alloy includes a Fe-rich material.

3. The CURA method of claim 1, wherein the alloy includes (Fe_{0.8}Co_{0.2})₈₆B₁₄.

4. The CURA method of claim 1, wherein the length of time is less than about ten seconds.

5. The CURA method of claim 1, wherein the length of time is less than about three seconds.

6. The CURA method of claim 1, wherein the tension is about 10 MPa.

7. The CURA method of claim 1, wherein the amorphous ribbons are directly contacted with the Cu wheel under a nitrogen flow atmosphere.

8. The CURA method of claim 1, further comprising air cooling the nanocrystalline alloy.

9. A nanocrystalline (Fe_{0.8}Co_{0.2})₈₆B₁₄ alloy produced by a CURA process, the CURA process comprising directly contacting amorphous ribbons between a first reel and a second reel with a preheated Cu wheel for a length of time under tension to produce the nanocrystalline (Fe_{0.8}Co_{0.2})₈₆B₁₄ alloy.

10. The nanocrystalline (Fe_{0.8}Co_{0.2})₈₆B₁₄ alloy of claim 9, wherein the nanocrystalline (Fe_{0.8}Co_{0.2})₈₆B₁₄ alloy has a saturation magnetic polarization greater than 2 T and a coercivity less than 10 A/m.

11. The nanocrystalline (Fe_{0.8}Co_{0.2})₈₆B₁₄ alloy of claim 9, wherein the length of time is less than about three seconds.

12. The nanocrystalline (Fe_{0.8}Co_{0.2})₈₆B₁₄ alloy of claim 9, wherein the Cu wheel is preheated to a temperature of about 750° K to about 800° K.

13. The nanocrystalline (Fe_{0.8}Co_{0.2})₈₆B₁₄ alloy of claim 9, wherein the tension is about 10 MPa.

14. The nanocrystalline (Fe_{0.8}Co_{0.2})₈₆B₁₄ alloy of claim 9, wherein the nanocrystalline (Fe_{0.8}Co_{0.2})₈₆B₁₄ alloy is used to prepare a stator.

15. The nanocrystalline (Fe_{0.8}Co_{0.2})₈₆B₁₄ alloy of claim 11, wherein the stator is part of an electric motor.

16. A Continuous Ultra-Rapid Annealing (CURA) method for producing a nanocrystalline alloy, the method comprising directly contacting amorphous ribbons between a first reel and a second reel with a preheated Cu wheel for a length of time under tension to produce the nanocrystalline alloy.

17. The CURA method of claim 16, wherein the alloy includes (Fe_{0.8}Co_{0.2})₈₆B₁₄.

18. The CURA method of claim 16, wherein the length of time is less than about three seconds.

19. The CURA method of claim 16, wherein, the tension is about 10 MPa.

20. The CURA method of claim 16, wherein the amorphous ribbons are directly contacted with the Cu wheel under a nitrogen flow atmosphere.

21. A nanocrystalline (Fe_{0.8}Co_{0.2})₈₆B₁₄ alloy with a saturation magnetic polarization greater than 2 T and a coercivity less than 10 A/m.

22. An electric motor comprising a stator, wherein nanocrystalline (Fe_{0.8}Co_{0.2})₈₆B₁₄ alloy is used to prepare the stator.

23. The electric motor of claim 22, wherein the stator includes a nanocrystalline (Fe_{0.8}Co_{0.2})₈₆B₁₄ alloy core.

24. The electric motor of claim 22, wherein the nanocrystalline (Fe_{0.8}Co_{0.2})₈₆B₁₄ alloy is produced by a CURA process, the CURA process comprising directly contacting amorphous ribbons between a first reel and a second reel with a preheated Cu wheel for a length of time under tension to produce the nanocrystalline (Fe_{0.8}Co_{0.2})₈₆B₁₄ alloy.

25. The electric motor of claim 22, wherein the Cu wheel is preheated to a temperature of about 750° K to about 800° K.

26. The electric motor of claim 22, wherein the length of time is less than about three seconds.

27. The electric motor of claim 22, wherein the tension is about 10 MPa.

28. The electric motor of claim 22, wherein the amorphous ribbons are directly contacted with the Cu wheel under a nitrogen flow atmosphere.

29. The electric motor of claim 22, wherein the nanocrystalline (Fe_{0.8}Co_{0.2})₈₆B₁₄ alloy has a saturation magnetic polarization greater than 2 T and a coercivity less than 10 A/m.
